(19) United States
(12) Patent Application Publication
(10) Pub. No.: US 2009/0288484 A1
(43) Pub. Date: Nov. 26, 2009

(54) INTEGRATED MECHANICAL PACKAGE DESIGN FOR COMBI SENSOR APPARATUS

(75) Inventors: Thirumani Selvan, Bangalore (IN); Saravanan Sadasivan, Bangalore (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/124,798

(22) Filed: May 21, 2008

(51) Int. Cl. G01N 27/00

(52) U.S. Cl. 73/335.02

(57) ABSTRACT

An integrated mechanical combi sensor apparatus and method for measuring humidity, pressure and temperature. A pressure sensor and an ASIC can be mounted in a first compartment, and a temperature sensor mounted in a second compartment of a housing. Similarly, a humidity sensor can be mounted in a third compartment such that the pressure sensor, temperature sensor, and humidity sensor are isolated from each other. The sensor element associated with the sensors and the ASIC can be connected to a lead frame terminal by wire bonding for electrical connection. A pressure cover and a humidity cover can be utilized for covering the pressure sensor and the humidity sensor. The humidity sensor can include a hydrophobic filter for preventing moisture-saturated air from reaching the sensing element in order to provide accurate sensor measurements thereof.

### TECHNICAL FIELD

Embodiments are generally related to sensor methods and systems. Embodiments are also related to combi sensors. Embodiments are additionally related to integrated electromechanical package designs for sensing pressure, humidity and/or temperature.

### BACKGROUND OF THE INVENTION

Various types of sensors are utilized for detecting atmospheric parameters such as humidity, pressure, temperature, and so forth. Examples of sensing applications include weather monitoring radiosonde applications, process control devices, medical equipment control, and the like. Typical sensor instrumentation utilized in such applications, for example, utilize more than one measure and simultaneously to determine calculations for measurements in the system. Usually the individual sensors utilized in such systems cover a larger area and are provided with calibrated or un-calibrated analog outputs or in the form of sensors with small-signal outputs. Such outputs need to be conditioned and calibrated by the end user within the system.

Signal conditioning circuits are often utilized as an interface in a signal conditioning unit to convert a differential input signal received from a data source into a more usable output signal. Signal conditioning circuits can be utilized in conjunction with sensors to receive a sensor input signal and convert the input signal into an output voltage utilized by a control system. The majority of prior art sensing applications possess limited sensing capabilities. Such sensing applications utilize separate signal conditioning circuits to condition raw signals from the sensor, regardless of the quantity being measured by the sensor. This approach results in a large amount of secondary operations, which lead to more processing time and inaccurate results. Additionally, the installation cost for packaging the individual sensors for such applications increases, which further increases the size of the package.

Based on the foregoing it is believed that a need exists for an improved electromechanical package design for sensing pressure, humidity temperature and so forth, as described in greater detail herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved sensor method and system.

It is another aspect of the present invention to provide for an improved combi sensor for measuring humidity, pressure and temperature.

It is a further aspect of the present invention to provide for an improved mechanical packaging design for a combi sensor.

The aforementioned aspects and other objectives and advantages can now be achieved as described herein. An integrated electromechanical package for a combi sensor that can detect and measure humidity, pressure and temperature, is disclosed. A pressure sensor and an Application Specific Integrated Circuit (ASIC) can be mounted in a first compartment and a temperature sensor can be mounted in a second compartment of a housing. Similarly, a humidity sensor can be mounted in a third compartment and can be isolated from the pressure sensor and the ASIC. The sensing element(s) associated with such sensors and the ASIC can be connected to a lead frame terminal utilizing wire bonds for electrical connection thereof. A pressure cover and a humidity cover along with a conformal coating can enclose and maintain the pressure sensor and the humidity sensor. An example of such a conformal coating is a “glob-top”, which is a variant of conformal coating utilized in chip-on-board assembly components. A “glob-top” is typically provided as a drop of specially formulated resin deposited over a semiconductor chip and its wire bonds, for example, to provide mechanical support and exclude contaminants such as fingerprint residues which could disrupt circuit operation. The disclosed humidity sensor generally includes a hydrophobic filter for preventing moisture-saturated air from reaching the sensing element in order to provide accurate sensor measurements.

The sensor package can be implemented as a dual in package (DIP) or a surface mount type (SMT), which has lower costs and is smaller in size. The humidity sensor can be exposed to the environment and isolated from the environment for application requirement. The pressure sensor generally incorporates the ASIC, which includes an instrumentation amplifier or an operational amplifier for amplification to the individual sensor output. The sensing element and the ASIC can be electrically connected together internally or externally of the package. Preferably, one or more lead frames, carried on the housing, are electrically connected to the sensors and the ASIC so that the sensors and the ASIC are electrically connected via the lead frame to a printed circuit board.

The sensing element can be electrically connected to the ASIC via the printed circuit board. The ASIC can be integrated in the package for receiving the output signal, whereby, when the ASIC is electrically coupled to the sensing element, the ASIC can condition the output signal and provide a conditioned output. The ASIC preferably includes temperature compensation and amplification of the sensor signal. The combi sensor disclosed herein can therefore be utilized to sense temperatures and/or pressures, along with humidity while offering a high accuracy and faster response time.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a perspective view of a combi sensor, in accordance with a preferred embodiment;

FIG. 2 illustrates a perspective view of a pressure sensor, a humidity sensor, a thermal sensor (e.g., a thermistor) and a housing, in accordance with a preferred embodiment;

FIG. 3 illustrates a plan view of the combi sensor associated with compartments, in accordance with a preferred embodiment;

FIG. 4 illustrates a cross sectional view of the combi sensor with wire bonds, in accordance with a preferred embodiment;

FIG. 5 illustrates a process map depicting the process of designing the combi sensor, in accordance with a preferred embodiment;

FIG. 6 illustrates a high level block diagram of a multi bridge interface signal conditioning module, in accordance with a preferred embodiment;

FIG. 7 illustrates a detailed functional diagram of the pressure sensor, in accordance with a preferred embodiment;

FIG. 8 illustrates a detailed functional block diagram illustrating the electrical components of the ASIC and piezo resistive silicon die of the pressure sensor disclosed herein, in accordance with a preferred embodiment; and

FIG. 9 illustrates a flow chart of operations illustrating operational steps of a method for configuring a combi sensor, in accordance with a preferred embodiment.

### DETAILED DESCRIPTION

The particular values and configurations discussed in these non-limiting examples can be varied and are cited merely to illustrate at least one embodiment and are not intended to limit the scope thereof.

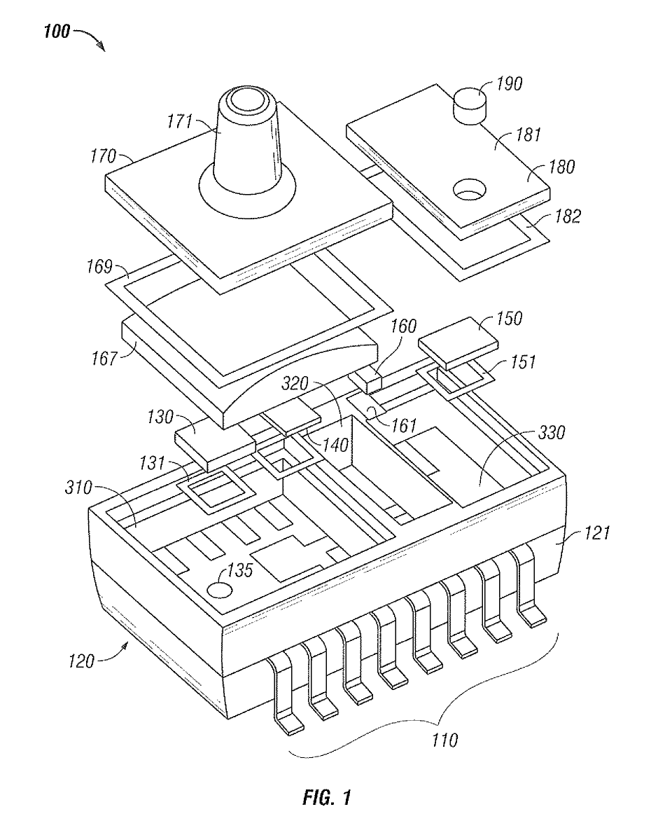

FIG. 1 illustrates a perspective view of a combi sensor apparatus 100, which can be implemented in accordance with a preferred embodiment. Note that the term “combi sensor”, as utilized herein, generally refers to a combination sensor that can detect more than one environmental parameter, such as, for example, temperature, pressure, humidity, etc. The combi sensor apparatus 100 generally incorporates a pressure sensor 130, a temperature sensor 160 (e.g., a thermistor) and a humidity sensor 150. Apparatus 100 further includes an Application Specific Integrated Circuit (ASIC) 140 that is associated with the pressure sensor 130. ASIC 140 can be provided as an ASIC die. The pressure sensor 130 can be mounted within a first housing compartment 310. The pressure sensor 130 can be provided as a pressure sense die. A die attach epoxy 131 can also be provided with respect to the pressure sense die 130.

The ASIC 140 can be placed within a housing 120 which can be connected to a lead frame 110. The housing 120 includes a housing bottom 121. One or more electrical leads generally form a lead frame 110 that extends from housing 120. The pressure sensor 130 (i.e., pressure sense die component) and the ASIC 140 can thus be mounted within the first compartment 310 and covered with a coating 167 such as, for example, a glob-top, and a protective cover 170 (i.e., a pressure cover) to prevent exposure of ASIC 140 with the detected media. Additionally, an additional housing component 169 can be provided in association with the coating 167 and the protective cover 170. Note that the housing 120 can be configured to include a hole 135 for gage pressure sensing applications. Note that in some embodiments the protective cover 170 can be shaped to include a protruding cover portion 171.

Apparatus 100 also includes a humidity sensor 150 for measuring humidity. The humidity sensor 150 can be installed in a third compartment 330 of the housing 120. The humidity sensor 150 can be enclosed by a protective cover 180 (i.e., a humidity cover) and a hydrophobic filter 190 that prevents moisture-saturated air from reaching the other sensing elements in order to provide sensor accurate measurements utilizing apparatus 100. A lid attach epoxy 182 can also be provided with respect to the humidity cover 180 and above the humidity sense die or humidity sensor 150. A humidity die attach component 151 is located below the humidity sensor 150.

The temperature sensor or thermistor 160 can be utilized to detect temperatures, and is mounted within a second compartment 320. A conductive epoxy 161 can also be provided with respect to the thermistor 160. The entire package for configuring and maintaining apparatus 100 can be configured in a dual in-line package (DIP) type or a surface-mount type (SMT), depending upon design considerations and applications. The DIP is an electronic device package that can configured with a rectangular housing such as housing 120 and two parallel rows of electrical connecting pins, usually protruding from the longer sides of the package and bent downward which form the lead frame 110. Similarly, in SMT, surface mounted components (SMC) can be mounted directly to the surface of a PCB.

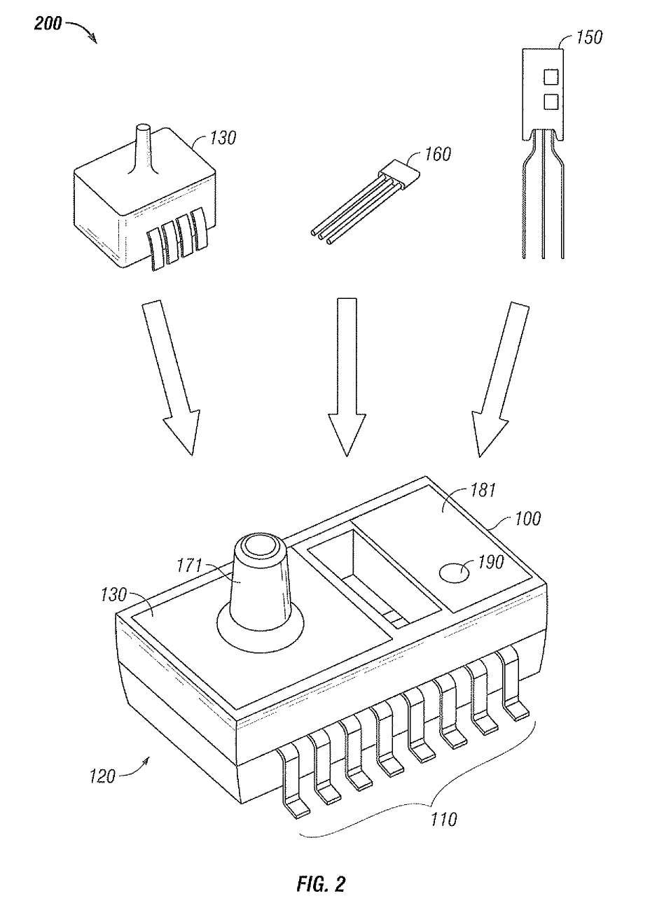

FIG. 2 illustrates a perspective view of the pressure sensor 130, the humidity sensor 150, the thermistor 160 and the housing 120, in accordance with a preferred embodiment. Note that in FIGS. 1-9, identical or similar blocks are generally indicated by identical reference numerals. The pressure sensor 130, the humidity sensor 160 and the temperature sensor 160 can be incorporated within housing 120 in order to form apparatus 100, which in turn can be utilized to measure pressures and temperatures and a condensed humid environment.

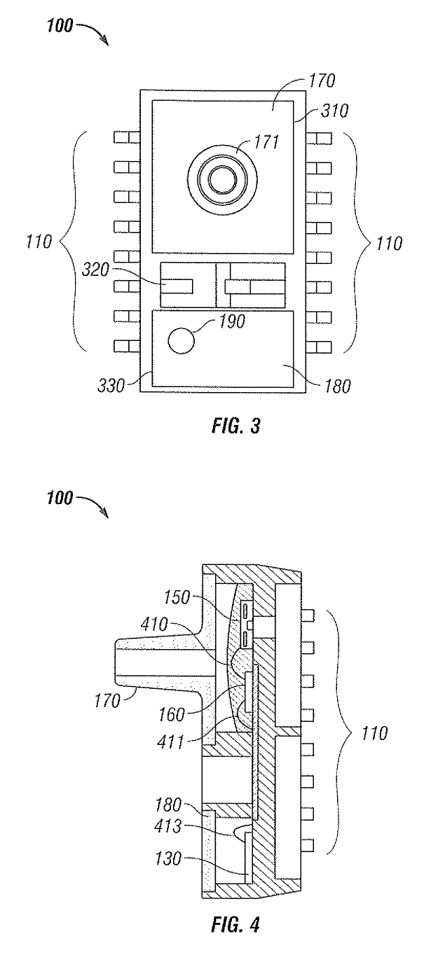

FIG. 3 illustrates a plan view of the apparatus 100, in accordance with a preferred embodiment. As in indicated in the illustration of FIG. 3, apparatus 100 includes the first compartment 310, the second compartment 320 and the third compartment 330. The first compartment 310 includes pressure sensor 130, which is electrically coupled to the ASIC 140. Media pressure can be applied to the pressure sensor 130. The second compartment 320 includes the temperature sensor 160 for sensing temperature. The third compartment 330 includes the humidity sensor 150, a top cap 180 and hydrophobic filter 190, which assist in providing accurate sensing measurements via apparatus 100.

FIG. 4 illustrates a cross-sectional view of the apparatus 100 with wire bonds 410, in accordance with a preferred embodiment. Again, as a reminder with respect to FIGS. 1-9, identical or similar elements and components are generally indicated by identical reference numerals. Apparatus 100 includes bond wires 410, 411, and 413 which can be utilized for electrical connection between the pressure sensor 130, and the humidity sensor 150 with the ASIC 140 via lead frame 110. Preferably, the lead frame 110 carried on the housing 120 can be electrically connected to the sensors 130, and 160 and the ASIC 140 utilizing wire bonds 410 so that sensors 130, 150 and 160 and the ASIC 140 can be electrically connected via the lead frame 110 to a PCB in some embodiments.

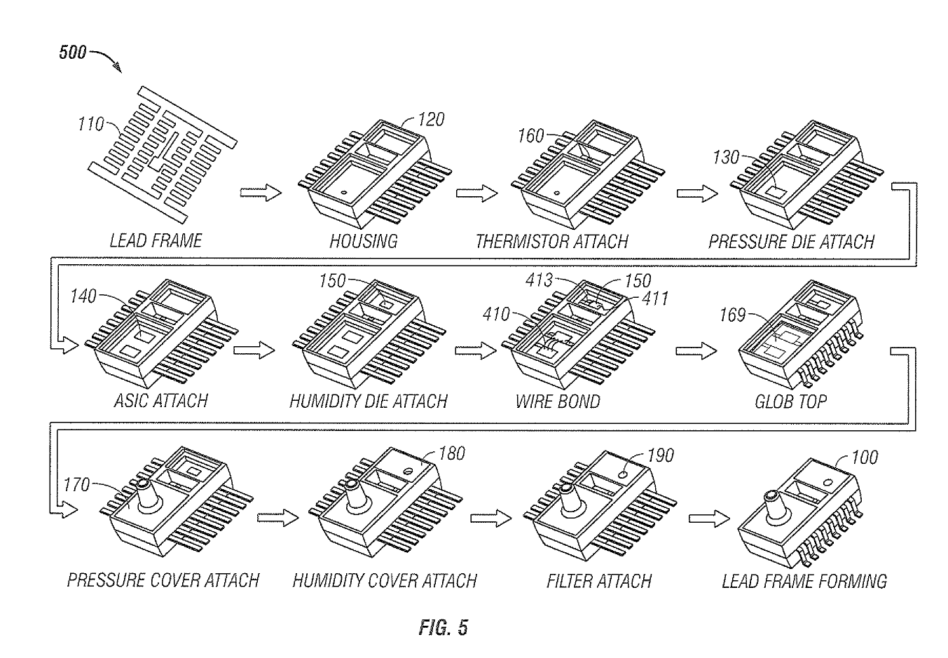

FIG. 5 illustrates a process map 500 depicting a general process of designing and configuring the apparatus 100, in accordance with a preferred embodiment. As indicated in FIG. 5, the lead frame 110 can be incorporated in association with the housing 120. The temperature sensor 160 can be mounted in the second middle compartment 320 of the housing 120. The pressure sensor 130 can be mounted in the first compartment 310, which generally includes a hole 135 in the housing 120 for gage pressure sensing application. The hole 135 is closed for absolute pressure sensing application. The ASIC 140 can also be attached in the first compartment 310 where the pressure sensor 130 is mounted.

Next, the humidity sensor 150 can be mounted in the third compartment 330. The electrical connections can be made between the ASIC 140 and pressure sensors 130 utilizing the wire bonds 410. The sensors 150 and 160 can be electrical coupled to ASIC 140 utilizing the lead frame 110 externally on a PCB. Further, the protective glob-top 169 and pressure cover 170 can be attached to the first compartment 310 to protect the ASIC 140 from the media. The third compartment 330 can be attached with the humidity cover 180 for covering the humidity sensor 150 and with the hydrophobic filter 190. Finally, the apparatus 100 can be designed utilizing the lead frame 110 for sensing temperature, pressure and humidity.

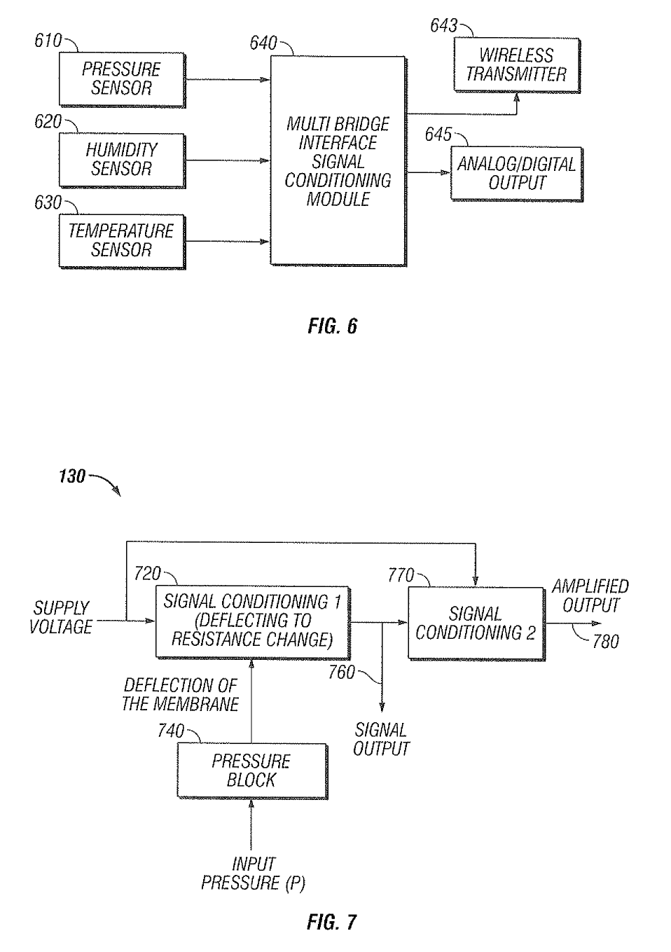

FIG. 6 illustrates a high-level block diagram of a system 600 that includes a multi bridge interface signal-conditioning module 640, in accordance with a preferred embodiment. The multi bridge interface signal-conditioning module communicates electronically with a wireless transmitter 643 and receives data from a pressure sensor 610, a humidity sensor 620, and a temperature sensor 630. The module 640 provides an analog/digital output 645. The multi bridge interface signal conditioning module 640 converts one or more signals received from pressure sensor 610, humidity sensor 620, and temperature sensor 630 respectively into a conditioned analog and/or digital output signal 645. The signal-conditioning module 640 can be an ASIC, an instrumentation amplifier, or an operational amplifier, and optionally a temperature compensating circuit. The output module can also give digital output and transmit the same by wireless transmitter 643.

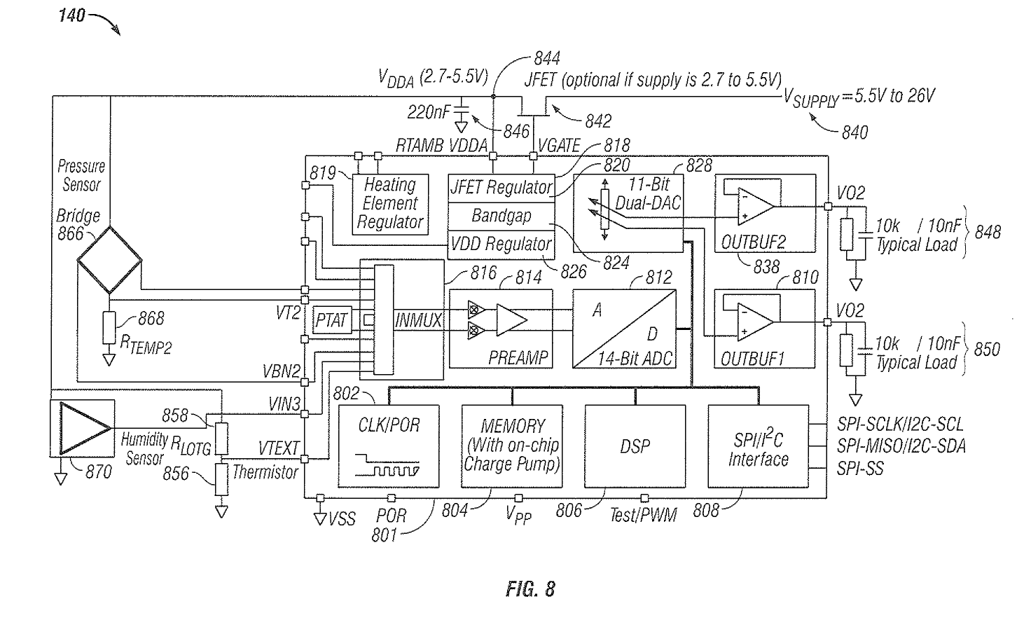

FIG. 7 illustrates a detailed functional diagram of the pressure sensor 130, in accordance with a preferred embodiment. An input pressure P can be given as input to a pressure block 740, which includes a pressure element associated with a membrane (not shown), which can be deflected due to the applied pressure. The first signal conditioner 720 changes the deflection of the membrane to a change in resistance by supplying a supply voltage Vₛ. This change of resistance causes the sensor output voltage 760 denoted as V₀ to change. The sensor output signal 760 representing the applied pressure P is then fed to the signal conditioner 770, which conditions the sensor signal. Signal conditioner 770 receives the change in output signal voltage 760 and accordingly conditions the change in sensor signal. The signal conditioner 770 preferably includes temperature compensation and amplification of the sensor signal.

FIG. 8 illustrates a detailed functional block diagram illustrating possible electrical components of an ASIC 140, which may be adapted for use in accordance with a preferred embodiment. It can be appreciated by those skilled in the art that ASIC 140 represents merely one possible type of ASIC that can be adapted for use in accordance with the disclosed embodiments. Other types of ASIC devices can be utilized in place of ASIC 140, which is depicted and described herein for general illustrative and exemplary purposes only. ASIC 140 can be provided as a Heimdal dual bridge sensor signal conditioner with temperature compensation capabilities. A general description of such a Heimdal device is disclosed in the Honeywell “ZMD Heimdal Combi-Sensor ASIC” document dated Nov. 23, 2006 and “Released Per JR-91841” which is incorporated by reference herein in its entirety. ASIC 140 can be configured to include a variety of components, such as, for example, a clock 802 in association with a memory 804 (e.g., with on-chip pump), a DSP (Digital Signal Processor) 806, and an SPI/I²/C Interface 808.

Additionally, a multiplexer (MUX) 816 can be provided in association with a preamplifier unit 814 and an Analog-to-Digital converter 802, Output buffers 810 and 838 can also be provided in addition to electrical components 848 and 850. An electrical unit 818 can also be provided which includes a JFET regulator 820, a bandgap component 824, and a voltage regulator 826. A Dual-DAC component 821 can also be provided, which communicates electrically with the output buffer 838. Other components such as a JFET 842 (which is optional if the voltage supply is in the range of 2.7 to 5.5 v) is also provided and is connected electrically to a capacitor 846, which are both in turn connected to voltage supply 844 (V_{DDA}) A heating element regulator 819 can also form a part of ASIC 140. The heating element regulator 819 can connect to, for example, a resistor.

Other components such as a bridge circuit 866 can be provided in association with a resistor 868. Bridge circuit 866 is generally connected to node VBP2 and node VT2 and also electrically connected to the R_{TEMP2} resistor component 868, which in turn is electrically connected to ground. The bridge circuit 866 can also function as a pressure sensor and can be electrically connected to capacitor 846, which may possess, for example, a capacitance value of 220 nF and is connected to a voltage V_{DDA} 844, which may be provided in a voltage range of, for example, 2.7V to 5.5V. The voltage node 844 can in turn be connected to the optional JFET 842.

Additionally a humidity sensor 870 can also be provided with respect to resistor 858 (R_{LOTG}) and thermistor 856. The humidity sensor 870 is also electrically connected to node VIN3 and the voltage node 844. Note that a node VTEXT is electrically coupled to both resistor 858 and thermistor 856. The thermistor 856 is in turn connected to ground. It can be appreciated that the components depicted in FIG. 8 represent merely possible components utilized for the implementation of ASIC 140. Other types of components and arrangements of electrical elements are also possible. Again, as a reminder, the specific arrangement depicted in FIG. 8 is not intended to limit the scope of the present invention disclosed herein, but is merely provided for general edification and illustrative purposes only.

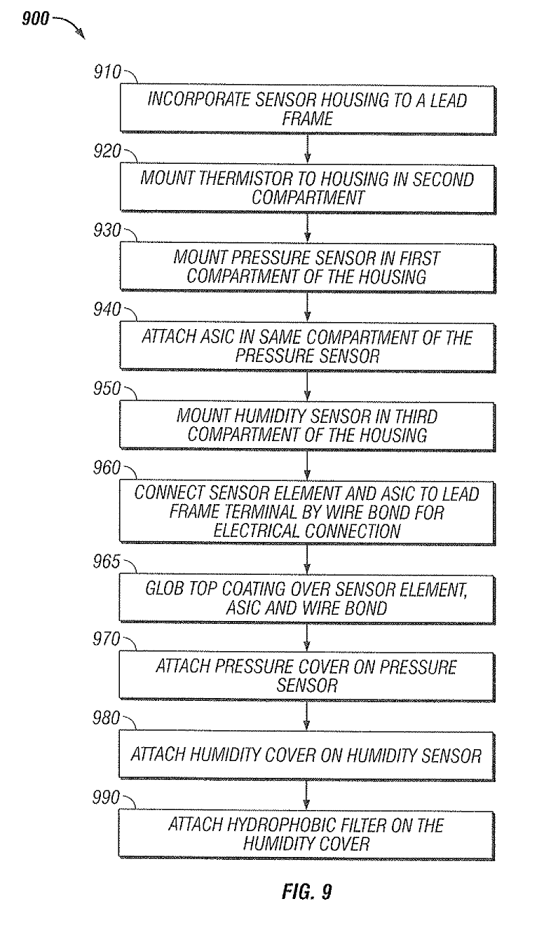

FIG. 9 illustrates a flow chart of operations illustrating operational steps of a method 900 for designing apparatus 100, in accordance with a preferred embodiment. A lead frame 110 can be incorporated into a housing 120, as depicted at the block 910. Thereafter, a temperature sensor 160 can be mounted to the housing 120 in a second compartment 320, as shown at the block 920. Next, a pressure sensor 130 can be mounted on the housing 120 in a first compartment 310, as depicted at block 930. ASIC 140 can be attached in the same compartment 310 of the pressure sensor 130, as depicted in block 940.

Thereafter, as illustrated at block 950, a humidity sensor 150 can be mounted in a third compartment 330 of the housing 120. The sensor element and the ASIC 140 can be connected to the lead frame terminal 110 utilizing wirebonds 410, as illustrated at block 960. An operation can then be performed as indicated at block 965, which involves a glob top coating placed over the sensor element, the ASIC 140 and the wirebonds 410. The pressure sensor 130 can be covered by a pressure cover 170, as indicated at block 970. Next, the humidity cover 180 can be utilized to cover the humidity sensor 150, as depicted at block 980. A hydrophobic filter 190 can be attached to the humidity cover 180, as shown at block 980. It is believed that by utilizing the combi sensor 100 described herein, the parameters such as pressure, temperature and humidity can be sensed utilizing a single package that is very small in size and cost effective. The resulting combi sensor apparatus 100 can thus sense low pressures and temperatures, along with humidity, while providing high accuracy and faster response time output.

Based on the foregoing, it can be appreciated that the apparatus 100 can be adapted for use in weather monitoring and other applications (e.g., Radiosonde applications), including products for measuring atmospheric parameters such as pressure, humidity and temperature. Apparatus 100 can be implemented as a miniature, low-cost integrated mechanical package design for pressure, humidity and temperature sensing applications. Thus, apparatus 100 constitutes a single product that possesses the capability of measuring a variety of parameters. The design of apparatus 100 also assists in lowering installation costs and eliminates the need for secondary operations. Apparatus 100 can cater to the needs of most applications requiring an SMT package and those applications where an amplified force reading is utilized. To incorporate amplification of the sensor output, an ASIC/instrumentation amplifier/operational amplifier can also be employed. The disclosed ASIC 140 can thus be utilized to bring about signal conditioning along with amplification.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method for configuring an integrated combi sensor apparatus, comprising:
mounting a pressure sensor and a signal conditioner in a first compartment of a housing associated with at least one lead frame of a combi sensor module;
mounting a temperature sensor in a second compartment and a humidity sensor in a third compartment associated with said housing; and
electrically coupling at least one sensing element associated with said pressure sensor, said temperature sensor and said humidity sensor to said signal conditioner in order to condition an output signal and generate a conditioned output thereof in order to permit said combi sensor module to measure environmental parameters with a high accuracy and faster response time.

2. The method of claim 1 further comprising covering said pressure sensor with a conformal coating and a pressure cover.

3. The method of claim 1 further comprising attaching a humidity cover and a hydrophobic cover to said humidity sensor, wherein said hydrophobic filter prevents moisture-saturated air from reaching a sensing element thereof.

4. The method of claim 1 further comprising configuring said housing as an SMT package.

5. The method of claim 1 further comprising configuring said housing as a DIP package.

6. The sensor of claim 1 further comprising configuring said signal conditioner to comprise an ASIC in association with an instrumentation amplifier and/or an operational amplifier.

7. The method of claim 1 further comprising electrically connecting said at least one lead frame to said at least one sensing element and said signal conditioner utilizing a plurality of wirebonds.

8. The method of claim 1 further comprising isolating said pressure sensor from said temperature sensor and said humidity sensor.

9. An integrated combi sensor apparatus, comprising:
a pressure sensor and a signal conditioner mounted in a first compartment of a housing associated with at least one lead frame of a combi sensor module;
a temperature sensor mounted in a second compartment and a humidity sensor in a third compartment associated with said housing; and
at least one sensing element associated with said pressure sensor, said temperature sensor and said humidity sensor, said at least one sensing element electrically coupled to said signal conditioner in order to condition an output signal and generate a conditioned output thereof in order to permit said combi sensor module to measure environmental parameters with a high accuracy and a faster response time.

10. The apparatus of claim 9 wherein said pressure sensor is maintained by a conformal coating and a pressure cover.

11. The apparatus of claim 9 wherein said humidity cover and a hydrophobic cover are attached to said humidity sensor, wherein said hydrophobic filter prevents moisture-saturated air from reaching a sensing element thereof.

12. The apparatus of claim 9 wherein said housing forms a part of an SMT package.

13. The apparatus of claim 9 wherein said housing forms a part of a DIP package.

14. The apparatus of claim 9 wherein said signal conditioner comprises an ASIC in association with an instrumentation amplifier and/or an operational amplifier.

15. The apparatus of claim 9 wherein said at least one lead frame is electrically connected to said at least one sensing element and said signal conditioner utilizing a plurality of wirebonds.

16. The apparatus of claim 9 wherein said pressure sensor is isolated from said temperature sensor and said humidity sensor.

17. An integrated combi sensor apparatus, comprising:
a pressure sensor and a signal conditioner mounted in a first compartment of a housing associated with at least one lead frame of a combi sensor module, wherein said pressure sensor is maintained by a conformal coating a pressure cover;
a temperature sensor mounted in a second compartment and a humidity sensor in a third compartment associated with said housing;
at least one sensing element associated with said pressure sensor, said temperature sensor and said humidity sensor, said at least one sensing element electrically coupled to said signal conditioner in order to condition an output signal and generate a conditioned output thereof in order to permit said combi sensor module to measure environmental parameters with a high accuracy and a faster response time; and
a hydrophobic cover, wherein said humidity cover and said hydrophobic cover are attached to said humidity sensor, wherein said hydrophobic filter prevents moisture-saturated air from reaching a sensing element thereof.

18. The apparatus of claim 17 wherein said signal conditioner comprises an ASIC in association with an instrumentation amplifier and/or an operational amplifier.

19. The apparatus of claim 17 wherein said at least one lead frame is electrically connected to said at least one sensing element and said signal conditioner utilizing a plurality of wirebonds.

20. The apparatus of claim 17 wherein said pressure sensor is isolated from said temperature sensor and said humidity sensor.
